(19) United States
(12) Patent Application Publication
(10) Pub. No.: US 2025/0281967 A1
(43) Pub. Date: Sep. 11, 2025

(54) PRESS DIE ASSEMBLY

(71) Applicant: TOYOTA BOSHOKU KABUSHIKI KAISHA, Aichi-ken (JP)

(72) Inventor: Masashi OHARA, Nisshin-shi (JP)

(73) Assignee: TOYOTA BOSHOKU KABUSHIKI KAISHA, Aichi-ken (JP)

(21) Appl. No.: 19/064,058

(22) Filed: Feb. 26, 2025

(30) Foreign Application Priority Data
Mar. 6, 2024 (JP) 2024-033751

(51) Int. Cl. B21J 13/03; B21D 13/02

(52) U.S. Cl. CPC B21J 13/03; B21D 13/02

(57) ABSTRACT

A press die assembly includes a fixed die and a movable die. The fixed die includes a fixed-side forming section that includes a first forming surface, and multiple metal fixed-side support blocks arranged in a planar direction. The fixed-side support blocks support the fixed-side forming section from a side opposite to the first forming surface. The movable die includes a movable-side forming section that includes a second forming surface that faces the first forming surface, and multiple metal movable-side support blocks arranged in the planar direction. The movable-side support blocks support the movable-side forming section from a side opposite to the second forming surface. The Young's moduli of the fixed-side support blocks increase with increasing proximity to a central portion of the first forming surface. The Young's moduli of the movable-side support blocks increase with increasing proximity to a central portion of the second forming surface.

### CROSS-REFERENCE TO RELATED APPLICATIONS

This application is based upon and claims the benefit of priority from Japanese Patent Application No. 2024-033751, filed on Mar. 6, 2024, the entire contents of which are incorporated herein by reference.

### BACKGROUND

### 1. Field

The present disclosure relates to a press die assembly.

### 2. Description of Related Art

Japanese Laid-Open Patent Publication No. 2015-131344 discloses a press die assembly that includes a lower die and an upper die, which are configured to press a sheet material. The forming surfaces of the lower die and the upper die are formed by segments that are separated from each other. The segments of the lower die and the upper die are supported on a base using shims.

In the press die assembly disclosed in the above-described publication, the central portion of each forming surface is more likely to be deformed by the pressure during press forming than the peripheral portion. In such cases, insufficient pressing pressure is applied to the central portion of the workpiece, resulting in an uneven distribution of pressing pressure on the workpiece. Consequently, the forming accuracy of the press die assembly may be adversely affected.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a press die assembly includes a fixed die and a movable die configured to move toward and away from the fixed die. The press die assembly is configured to press a metal sheet. The fixed die includes a fixed-side forming section that includes a first forming surface, and multiple metal fixed-side support blocks arranged in a planar direction that is orthogonal to a movement direction of the movable die. The fixed-side support blocks support the fixed-side forming section from a side opposite to the first forming surface in the movement direction. The movable die includes a movable-side forming section that includes a second forming surface that faces the first forming surface, and multiple metal movable-side support blocks arranged in the planar direction. The movable-side support blocks support the movable-side forming section from a side opposite to the second forming surface in the movement direction. Young's moduli of the fixed-side support blocks increase with increasing proximity to a central portion of the first forming surface in the planar direction. Young's moduli of the movable-side support blocks increase with increasing proximity to a central portion of the second forming surface in the planar direction.

Other features and aspects will be apparent from the following detailed description, the drawings, and the claims.

### BRIEF DESCRIPTION OF THE DRAWINGS

FIG. 1 is a plan view of a separator for a fuel cell that is manufactured using a press die assembly according to an embodiment.

FIG. 2 is a cross-sectional view taken along line 2-2 in FIG. 1.

FIG. 3 is a cross-sectional view of a press die assembly according to the embodiment.

FIG. 4 is a plan view of the fixed-side support block shown in FIG. 3.

FIG. 5 is a plan view showing a positional relationship between the fixed-side support block shown in FIG. 3 and a first forming surface.

FIG. 6 is a plan view showing a positional relationship between the movable-side support block shown in FIG. 3 and a second forming surface.

FIG. 7 is a plan view showing a positional relationship between a fixed-side support block and a first forming surface according to a first modification.

FIG. 8 is a plan view showing a positional relationship between a fixed-side support block and a first forming surface according to a second modification.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

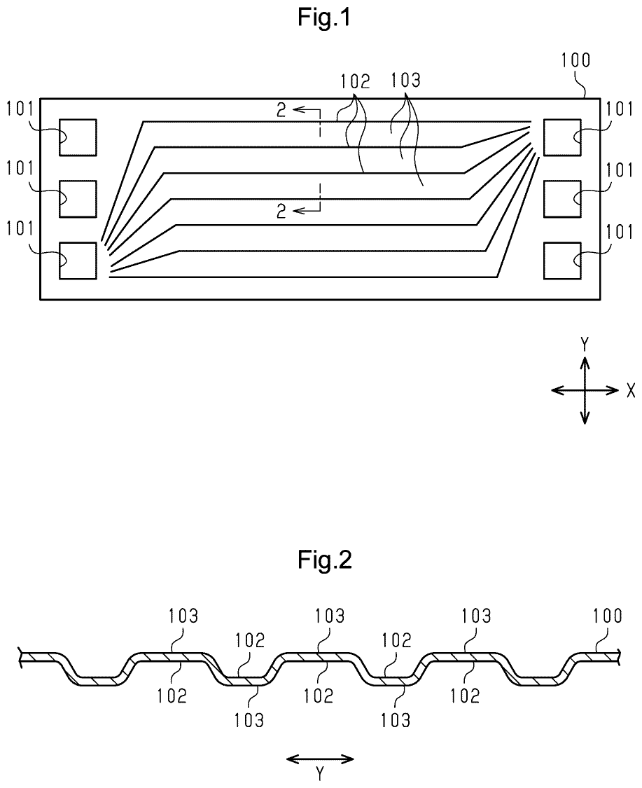

A press die assembly 10 according to an embodiment will now be described with reference to FIGS. 1 to 6.

The press die assembly 10 produces a separator 100 for a fuel cell by pressing a metal sheet M.

First, the structure of the separator 100 will be described.

### Separator 100

As shown in FIG. 1, the separator 100 has the shape of a rectangular sheet with long sides and short sides.

In the following description, the long-side direction of the separator 100 will be referred to as a first direction X, and a direction orthogonal to both the first direction X and the thickness direction of the separator 100 will be referred to as a second direction Y. The second direction Y agrees with the short-side direction of the separator 100.

The material of the separator 100 is, for example, a metal material such as stainless steel or titanium.

The separator 100 includes three manifolds 101 at each of the opposite ends in the first direction X. Fluid is suppled or discharged through the manifolds 101. The manifolds 101 extend through the separator 100 in the thickness direction. The fluid is, for example, any one of fuel gas such as hydrogen, oxidant gas such as air, and coolant.

As shown in FIG. 2, the separator 100 includes groove-shaped flow passages 102 on the opposite surfaces in the thickness direction. Fluid flows through the flow passages 102. The flow passages 102 are provided in parallel in the second direction Y. The flow passages 102 allow fluid to flow from a manifold 101 at one end in the first direction X of the separator 100 to a manifold 101 at the other end of the separator 100.

A rib 103 is provided between any two adjacent flow passages 102. The ribs 103 extend along the flow passages 102 and define the flow passages 102. The flow passages 102 that are provided on one side of the separator 100 act as ribs 103 on the other side of the separator 100. The ribs 103 that define the flow passages 102 on one side of the separator 100 act as flow passages 102 on the other side of the separator 100.

### Press Die Assembly 10

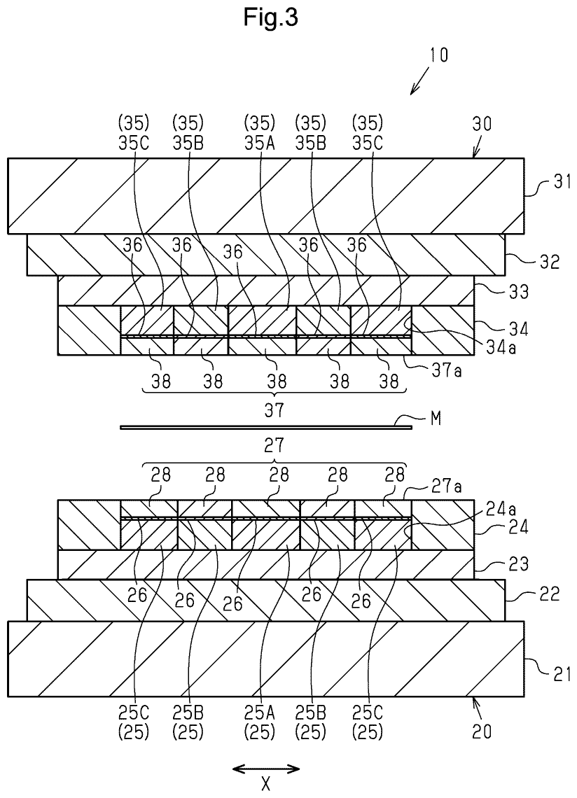

As shown in FIG. 3, the press die assembly 10 includes a fixed die 20 and a movable die 30 configured to move toward and away from the fixed die 20. The press die assembly 10 uses the fixed die 20 and the movable die 30 to press a metal sheet M, which is a base material of the separator 100, so as to form multiple flow passages 102 on the surfaces of the metal sheet M.

Hereinafter, the direction in which the movable die 30 moves toward and away from the fixed die 20 will simply be referred to as a movement direction, and a planar direction orthogonal to the movement direction will simply be referred to as a planar direction.

### Fixed Die 20

The fixed die 20 includes a press bed 21, a fixed-side shoe 22, and a fixed-side backing plate 23. The fixed-side shoe 22 is fixed to the upper surface of the press bed 21. The fixed backing plate 23 is fixed to the upper surface of the fixed-side shoe 22. The press bed 21, the fixed-side shoe 22, and the fixed-side backing plate 23 are made of metal.

The fixed die 20 includes a fixed-side holding plate 24, fixed-side support blocks 25, shims 26, and fixed-side forming section 27. The fixed-side holding plate 24 is fixed to the upper surface of the fixed-side backing plate 23. The fixed-side holding plate 24 has a holding hole 24a, which extends vertically through the fixed-side holding plate 24. The fixed-side support blocks 25, the shims 26, and the fixed-side forming section 27 are held in the holding hole 24a. The fixed-side holding plate 24, the fixed-side support blocks 25, the shims 26, and the fixed-side forming section 27 are made of metal.

The fixed-side forming section 27 includes a first forming surface 27a that forms the metal sheet M. The first forming surface 27a has protrusions and recesses for forming the flow passages 102 on the metal sheet M. The fixed-side forming section 27 is formed by fixed-side forming blocks 28, which are arranged side by side while being adjacent to each other in the planar direction. The first forming surface 27a is formed by continuous upper surfaces of the fixed-side forming blocks 28.

The fixed-side support blocks 25 are arranged side by side on the fixed-side backing plate 23 while being adjacent to each other in the planar direction. Each fixed-side support block 25 supports one of the fixed-side forming blocks 28 from a side opposite to the first forming surface 27a with the corresponding shim 26 in between. Each fixed-side support block 25 has the same shape as the fixed-side forming block 28 supported by the fixed-side support block 25 in plan view, and has a size smaller than or equal to that of the fixed-side forming block 28. Therefore, the arrangement of the fixed-side support blocks 25 in plan view is the same as the arrangement of the fixed-side forming blocks 28 in plan view.

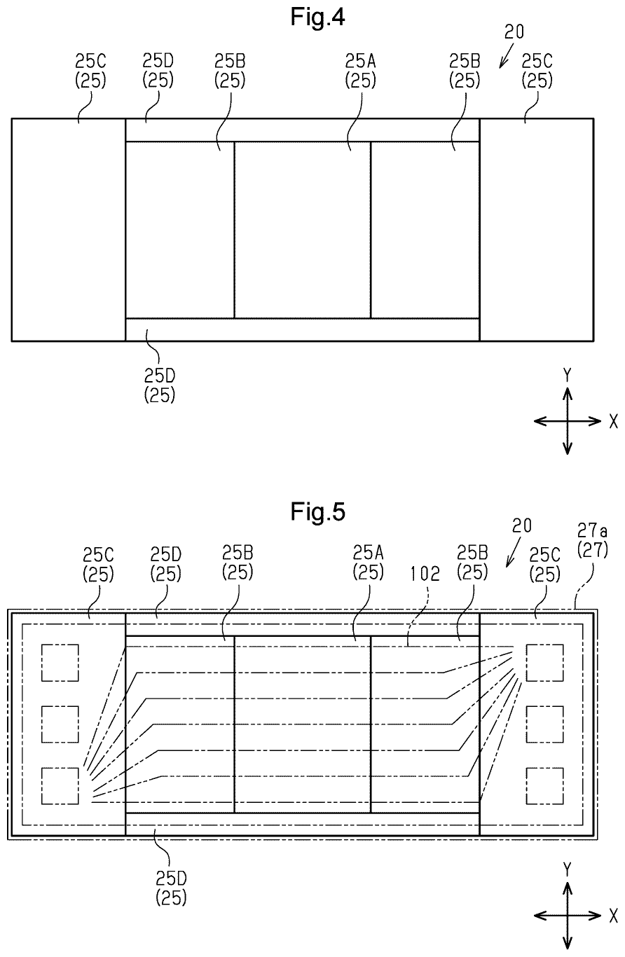

As shown in FIGS. 4 and 5, the fixed-side support blocks 25 are arranged in the long-side direction of the metal sheet M, that is, in the first direction X during press forming. The fixed-side support blocks 25 include one fixed-side support block 25A, two fixed-side support blocks 25B, two fixed-side support blocks 25C, and two fixed-side support blocks 25D.

As shown in FIG. 3, the fixed-side support block 25A supports the fixed-side forming block 28 that forms a central portion of the first forming surface 27a. The fixed-side support blocks 25B are adjacent to the opposite sides of the fixed-side support block 25A in the first direction X. Each fixed-side support block 25C is adjacent to a side of the corresponding fixed-side support block 25B that is opposite to the fixed-side support block 25A.

As shown in FIG. 4, the fixed-side support blocks 25D are adjacent to the opposite sides in the second direction Y of the fixed-side support block 25A and the fixed-side support blocks 25B. The opposite ends of each fixed-side support block 25D in the first direction X are adjacent to the fixed-side support blocks 25C in the first direction X.

As shown in FIGS. 3 and 5, a portion of the fixed-side forming section 27 that forms the flow passages 102 includes the central portion of the first forming surface 27a, and is formed by the fixed-side forming blocks 28. The portion of the fixed-side forming section 27 that forms the flow passages 102 is supported by the fixed-side support blocks 25A, 25B, and 25C.

The Young's moduli of the fixed-side support blocks 25 differ from each other. Specifically, the Young's moduli of the fixed-side support blocks 25 increase with increasing proximity to the central portion of the first forming surface 27a in the planar direction. In the present embodiment, among the fixed-side support blocks 25, the fixed-side support block 25A, which is closest to the central portion of the first forming surface 27a, has the highest Young's modulus. The Young's modulus of the fixed-side support blocks 25B is lower than the Young's modulus of the fixed-side support block 25A and higher than the Young's modulus of the fixed-side support blocks 25C. The Young's modulus of the fixed-side support blocks 25C is the same as the Young's modulus of the fixed-side support blocks 25D.

The difference in Young's modulus between the fixed-side support blocks 25 is achieved by differences in the materials. The fixed-side support block 25A is formed of, for example, a cemented carbide having a Young's modulus of approximately 600 GPa. The fixed-side support blocks 25B are formed of, for example, a cemented carbide having a Young's modulus of approximately 400 GPa. The fixed-side support blocks 25C and 25D are formed of, for example, an alloy tool steel having a Young's modulus of approximately 200 GPa.

The Young's modulus of the fixed-side support blocks 25C and 25D with the lowest Young's modulus among the fixed-side support blocks 25 is higher than the Young's modulus of the metal sheet M. In the present embodiment, the metal sheet M is made of, for example, a stainless steel having a Young's modulus of approximately 190 GPa.

The fixed-side forming blocks 28 are made of, for example, a high-speed tool steel having a Young's modulus of approximately 220 GPa. The fixed-side backing plate 23 and the shims 26 are made of, for example, alloy tool steels having Young's moduli of approximately 200 GPa.

### Movable Die 30

The movable die 30 has a similar configuration as the fixed die 20.

Hereinafter, the description of the structure of the movable die 30 may be omitted by assigning reference numerals “3*” obtained by adding “10” to the reference numerals “2*” used to indicate the structure of the fixed die 20.

As shown in FIG. 3, the movable die 30 includes a ram 31, a movable-side shoe 32, a movable-side backing plate 33, a movable-side holding plate 34, movable-side support blocks 35, shims 36, and a movable-side forming section 37. The movable-side support blocks 35, the shims 36, and the movable-side forming section 37 are held in a holding hole 34a of the movable-side holding plate 34.

The movable-side forming section 37 includes a second forming surface 37a that forms the metal sheet M. The second forming surface 37a faces the first forming surface 27a. The movable-side forming section 37 is formed by movable-side forming blocks 38, which are arranged side by side while being adjacent to each other in the planar direction. The second forming surface 37a is formed by continuous lower surfaces of the movable-side forming blocks 38.

The boundaries between the movable-side forming blocks 38 and the boundaries between the fixed-side forming blocks 28 are provided at positions displaced from each other in the planar direction. This prevents the metal sheet M from having unintended steps.

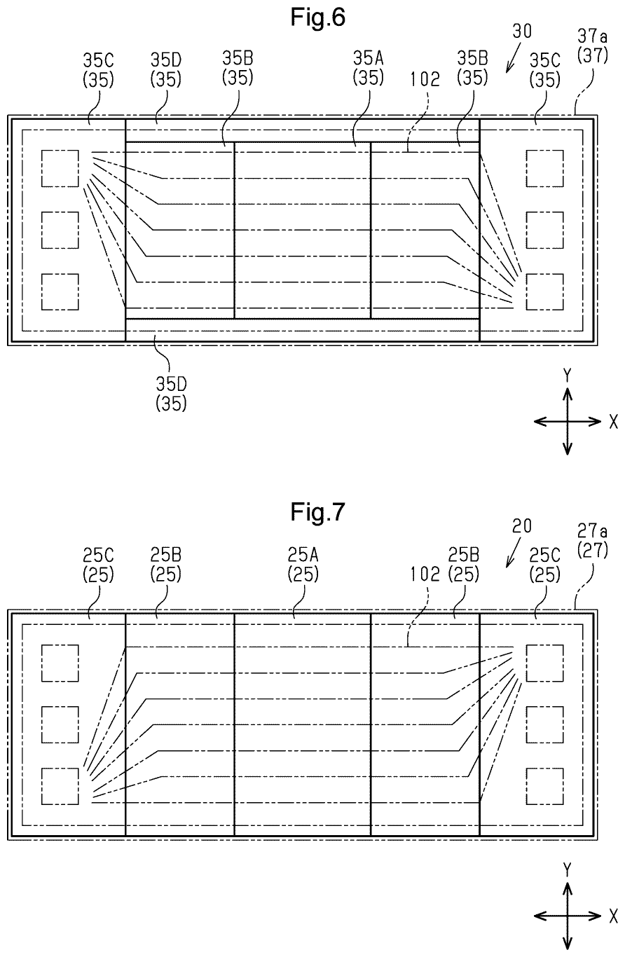

As shown in FIG. 6, the movable-side support blocks 35 include one movable-side support block 35A, two movable-side support blocks 35B, two movable-side support blocks 35C, and two movable-side support blocks 35D.

As shown in FIGS. 3 and 6, a portion of the movable-side forming section 37 that forms the flow passages 102 includes a central portion of the second forming surface 37a, and is formed by the movable-side forming blocks 38. The portion of the movable-side forming section 37 that forms the flow passages 102 is supported by the movable-side support blocks 35A, 35B, and 35C.

The Young's moduli of the movable-side support blocks 35 increase with increasing proximity to the central portion of the second forming surface 37a in the planar direction. In the present embodiment, among the movable-side support blocks 35, the movable-side support block 35A, which is closest to the central portion of the second forming surface 37a, has the highest Young's modulus. The Young's modulus of the movable-side support blocks 35B is lower than the Young's modulus of the movable-side support block 35A and higher than the Young's modulus of the movable-side support blocks 35C. The Young's modulus of the movable-side support blocks 35C is the same as the Young's modulus of the movable-side support blocks 35D.

The materials of the movable die 30 are the same as the materials of the fixed die 20. The Young's modulus of the movable-side support block 35A is thus the same as the

Young's modulus of the fixed-side support block 25A. The Young's modulus of the movable-side support blocks 35B is the same as the Young's modulus of the fixed-side support block 25B. The Young's modulus of the movable-side support blocks 35C and 35D is the same as the Young's modulus of the fixed-side support blocks 25C and 25D, and is higher than the Young's modulus of the metal sheet M.

### Operation of the Present Embodiment

The Young's moduli, which indicate the stiffness, of the fixed-side support blocks 25 increase with increasing proximity to the central portion of the first forming surface 27a in the planar direction. Consequently, during the press forming of the metal sheet M, the fixed-side support blocks 25 positioned closer to the central portion of the first forming surface 27a in the planar direction become progressively more resistant to deformation in the movement direction. Accordingly, the portions of the fixed-side forming section 27 closer to the central portion of the first forming surface 27a also become progressively more resistant to deformation in the movement direction.

Similarly, during the press forming of the metal sheet M, the movable-side support blocks 35 positioned closer to the central portion of the second forming surface 37a in the planar direction become progressively more resistant to deformation in the movement direction. Accordingly, the portions of the movable-side forming section 37 closer to the central portion of the second forming surface 37a also become progressively more resistant to deformation in the movement direction.

### Advantages of the Present Embodiment

(1) The fixed die 20 includes the fixed-side forming section 27, which includes the first forming surface 27a, and the fixed-side support blocks 25, which support the fixed-side forming section 27. The movable die 30 includes the movable-side forming section 37, which includes the second forming surface 37a, and the movable-side support blocks 35, which support the movable-side forming section 37. The Young's moduli of the fixed-side support blocks 25 increase with increasing proximity to the central portion of the first forming surface 27a in the planar direction. The Young's moduli of the movable-side support blocks 35 increase with increasing proximity to the central portion of the second forming surface 37a in the planar direction.

Since this configuration operates in the above described manner, the pressing pressure is prevented from being insufficient in the central part of the metal sheet M. This prevents uneven distribution of pressing pressure on the metal sheet M. This limits a reduction in the forming accuracy of the press die assembly 10.

In a case in which the metal sheet M is made of a stainless steel, the pressing pressure is likely to be increased, for example, as compared with a case in which the metal sheet M is made of a titanium material. In this configuration, even when the pressing pressure is increased, the pressing pressure acting on the metal sheet M is prevented from being uneven. This limits a reduction in the forming accuracy of the press die assembly 10.
(2) The Young's modulus of the fixed-side support blocks 25 with the lowest Young's modulus among the fixed-side support blocks 25 is higher than the Young's modulus of the metal sheet M. The Young's modulus of the movable-side support blocks 35 with the lowest Young's modulus among the movable-side support blocks 35 is higher than the Young's modulus of the metal sheet M.

This configuration prevents, during press forming, the fixed-side support blocks 25 with the lowest Young's modulus among the fixed-side support blocks 25 from being deformed prior to deformation of the metal sheet M. Similarly, this configuration prevents the movable-side support blocks 35 with the lowest Young's modulus among the movable-side support blocks 35 from being deformed prior to deformation of the metal sheet M. This limits a reduction in the forming accuracy of the press die assembly 10.
(3) The fixed-side support blocks 25 are arranged in the first direction X. The movable-side support blocks 35 are also arranged in the first direction X.

When the pressing pressure at the central portion of the metal sheet M, which has the long sides and the short sides, is insufficient, variations in the pressing pressure in the long-side direction of the metal sheet M tend to be greater than those in the short side direction.

In this regard, the fixed-side support blocks 25 and the movable-side support blocks 35 of the above-described configuration are arranged in the first direction X, which is the long-side direction of the metal sheet M during press forming. This prevents the pressing pressure acting on the metal sheet M from being uneven in the first direction X. This limits a reduction in the forming accuracy of the press die assembly 10.
(4) The portion of the fixed-side forming section 27 that forms the flow passages 102 includes the central portion of the first forming surface 27a and is supported by the fixed-side support blocks 25. The portion of the movable-side forming section 37 that forms the flow passages 102 includes the central portion of the second forming surface 37a and is supported by the movable-side support blocks 35.

With this configuration, the portion of the fixed-side forming section 27 that forms the flow passages 102 and the portion of the movable-side forming section 37 that forms the flow passages 102 resist deformation in the movement direction. This prevents the pressing pressure from being uneven in the portion of the metal sheet M where the flow passages 102 are formed. This increases the forming accuracy of the separator 100 for a fuel cell.

### Modifications

The above-described embodiment may be modified as follows. The above-described embodiment and the following modifications can be combined as long as the combined modifications remain technically consistent with each other.

As shown in FIG. 7, the fixed-side support blocks 25D may be omitted from the fixed-side support blocks 25. In this case, the fixed-side forming section 27 is supported by the fixed-side support block 25A, the two fixed-side support blocks 25B, and the two fixed-side support blocks 25C, which are arranged in the first direction X. This modification can be applied to the movable-side support block 35 in the same manner. This configuration also achieves the advantages of the above-described items (1) to (4).

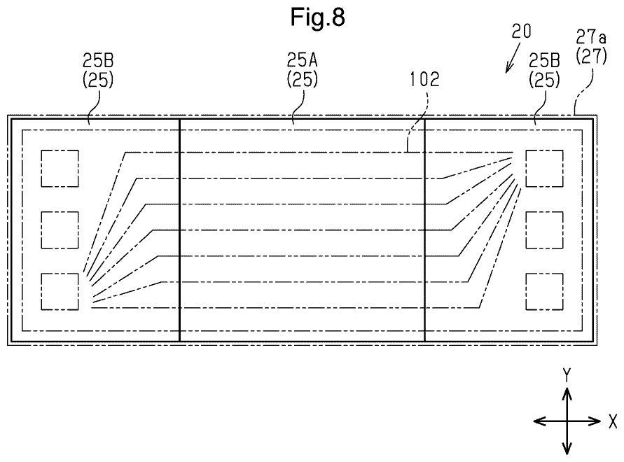

As shown in FIG. 8, the fixed-side support blocks 25C and 25D may be omitted from the fixed-side support blocks 25. In this case, the fixed-side forming section 27 is supported by the fixed-side support block 25A and the two fixed-side support blocks 25B, which are arranged in the first direction X. This modification can be applied to the movable-side support block 35 in the same manner. This configuration also achieves the advantages of the above-described items (1) to (4).

The metal sheet M is not limited to being used as the base material of the separator 100 and may also be used in various other products.

Two or more fixed-side support blocks 25 may be arranged in the short-side direction of the metal sheet M during press forming. This modification can be applied to the movable-side support block 35 in the same manner.

The Young's modulus of the fixed-side support blocks 25 with the lowest Young's modulus among the fixed-side support blocks 25 may be lower than or equal to the Young's modulus of the metal sheet M. In this case, the fixed-side support blocks 25 with the lowest Young's modulus preferably support a portion of the fixed-side forming section 27 that does not plastically deform the metal sheet M. This modification can be applied to the movable-side support block 35 in the same manner.

The fixed-side support blocks 25 may include a single fixed-side support block 25A and multiple fixed-side support blocks 25B that surround the outer circumference of the fixed-side support block 25A. Further, the fixed-side support blocks 25 may include multiple fixed-side support blocks 25C that surround the outer circumference of the fixed-side support blocks 25B. This modification can be applied to the movable-side support block 35 in the same manner.

The Young's modulus of the movable-side support block 35A does not necessarily need to be the same as the Young's modulus of the fixed-side support block 25A. The Young's modulus of the movable-side support blocks 35B does not necessarily need to be the same as the Young's modulus of the fixed-side support blocks 25B. The Young's modulus of the movable-side support blocks 35C and 35D does not necessarily need to be the same as the Young's modulus of the fixed-side support blocks 25C and 25D.

The fixed-side forming section 27 does not necessarily need to include multiple fixed-side forming blocks 28. The fixed-side forming section 27 may include a single block. This modification can be applied to the movable-side forming section 37.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A press die assembly, comprising:
a fixed die; and
a movable die configured to move toward and away from the fixed die, wherein
the press die assembly is configured to press a metal sheet,
the fixed die includes:
a fixed-side forming section that includes a first forming surface; and
multiple metal fixed-side support blocks arranged in a planar direction that is orthogonal to a movement direction of the movable die, the fixed-side support blocks supporting the fixed-side forming section from a side opposite to the first forming surface in the movement direction,
the movable die includes:
a movable-side forming section that includes a second forming surface that faces the first forming surface; and
multiple metal movable-side support blocks arranged in the planar direction, the movable-side support blocks supporting the movable-side forming section from a side opposite to the second forming surface in the movement direction,
Young's moduli of the fixed-side support blocks increase with increasing proximity to a central portion of the first forming surface in the planar direction, and
Young's moduli of the movable-side support blocks increase with increasing proximity to a central portion of the second forming surface in the planar direction.

2. The press die assembly according to claim 1, wherein the Young's modulus of the fixed-side support block with the lowest Young's modulus among the fixed-side support blocks, and the Young's modulus of the movable-side support block with the lowest Young's modulus among the movable-side support blocks, are each higher than a Young's modulus of the metal sheet.

3. The press die assembly according to claim 1, wherein
the metal sheet has a rectangular shape having long sides and short sides,
the fixed-side support blocks are arranged in a long-side direction of the metal sheet during press forming, and
the movable-side support blocks are arranged in the long-side direction of the metal sheet during press forming.

4. The press die assembly according to claim 1, wherein
the press die assembly is configured to press the metal sheet, which is a base material of a separator for a fuel cell, thereby forming groove-shaped flow passages, through which a fluid flows, on a surface of the metal sheet,
a portion of the fixed-side forming section that forms the flow passages includes the central portion of the first forming surface and is supported by the fixed-side support blocks, and
a portion of the movable-side forming section that forms the flow passages includes the central portion of the second forming surface and is supported by the movable-side support blocks.
